(19) United States
(12) Patent Application Publication
(10) Pub. No.: US 2005/0061797 A1
(43) Pub. Date: Mar. 24, 2005

(54) Lamp control method and method of controlling fixing device of image forming apparatus by using the lamp control method

(75) Inventors: Duk-soo Kim, Suwon-si (KR); Ui-choon Lee, Suwon-si (KR); Soo-cheol Park, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/947,443

(22) Filed: Sep. 23, 2004

(30) Foreign Application Priority Data
Sep. 23, 2003 (KR) 2003-65819

(51) Int. Cl. H05B 1/02

(52) U.S. Cl. 219/492

(57) ABSTRACT

A control method to control a lamp, which is used as a heat generator, including detecting a temperature of lamp, comparing the detected temperature of the lamp with a predetermined reference temperature, turning off a power supply to the lamp when the detected temperature of the lamp exceeds the predetermined reference temperature, and when the lamp stays in a turned-off state for more than a first time amount, supplying a half wavelength pulse to the lamp at intervals according to a second time amount. According to the lamp control method, reducing the inrush of current to the lamp is possible without requiring additional hardware. When applied to electronic apparatuses, the lamp control method reduces maximum value of the inrush of current in the stand-by mode.

### CROSS-REFERENCE TO RELATED APPLICATION

This application claims the benefit of Korean Patent Application No. 2003-65819, filed on Sep. 23, 2003, in the Korean Intellectual Property Office, the disclosure of which is incorporated herein by reference.

### BACKGROUND OF THE INVENTION

1. Field of the Invention

The present invention relates to a lamp control method, and, in particular to a lamp control method to minimize an inrush of current and a method of controlling an image forming apparatus to reduce an inrush of current by using the lamp control method.

2. Description of the Related Art

In general, light emission devices using a resistance of filament, such as incandescent lamps or halogen lamps, are widely used to heat treat or in common illumination, and, as for laser printers, such light emission devices are applied as fixing rollers to fix toner powder onto a paper.

Incandescent lamps usually take a form of a glass bulb, into which an inert gas such as argon (Ar) or neon (Ne) is introduced and in which a large tungsten filament is provided. Conversely, halogen lamps generally take a form of a glass bulb, into which a halogen gas is introduced so as to obtain a high brightness property. Typically, halogen lamps have a color temperature characteristic that is close to that of sunlight. Within a halogen lamp, a halogen gas may adhere to a tungsten filament to form a halogen compound. However, the halogen compound formed in such a way has a characteristic such that the halogen compound is decomposed when the internal temperature of the halogen lamp is high. Therefore, a black spot phenomenon, which causes a part of a lamp to be blackened, may occur. Nevertheless, most halogen elements that decompose from the halogen compound tend to adhere to the filament so as to lengthen the life of the filament. In addition, the surfaces of halogen lamps are typically capable of being heated to several hundred degrees centigrade depending on manufacturing processes thereof. Therefore, they are largely employed as heating elements. Accordingly, halogen lamps are often applied as fixing rollers to fix toner powder onto a paper, such as in a laser printer. Hereinbelow, the case in which a halogen lamp is applied as a heating element is described.

FIG. 1 conceptually illustrates a method of controlling a halogen lamp that is incorporated within a conventional fixing roller.

As shown in the drawing, a conventional halogen lamp 11 is driven by an AC power source 10. A triac 15 is connected between the AC power source 10 and the halogen lamp 11. The triac 15 is turned on/off by DC voltage applied from a switching section 13 so as to turn the interconnection between the halogen lamp 11 and the AC power source 10 on/off. A sensor 14 measures the temperature of the halogen lamp 11 and applies the measured temperature to the switching section 13. The switching section 13 performs on/off control of the triac 15 and is driven by DC current supplied from a rectifier 12.

Typically, the switching section 13 controls the triac 15 in such a manner that when a temperature detected by the sensor exceeds a preset temperature the switching section 13 turns off the triac 15 and when the detected temperature is lower than the preset temperature the switching section 13 turns on the triac 15.

FIG. 2 is a graph showing a driving characteristic of the halogen lamp 11 shown in FIG. 1. The graph shows the driving characteristic in relation to inflowing current (I) versus time (t) axes. As shown in the drawing, the halogen lamp 11 consumes the most current at the time when power is applied to the halogen lamp 11, i.e., at the time when the halogen lamp 11 is started. Concurrently, after a length of time has passed, a large amount of current is no longer required to drive the halogen lamp 11. This is due to the fact that when the filament (not shown) included within the halogen lamp has a lower temperature, e.g., when no power is applied, the filament (not shown) has a lower resistance value. Here, a large amount of electric current will pass through the filament. Conversely, when power is applied to the filament to preheat the filament, the filament has a higher resistance value. Here, a small amount of electric current will pass through the filament. The point “A” in the drawing indicates a peak electric value passing through the halogen lamp 11 as the AC power source 10 is inputted, when the halogen lamp 10 has a lower temperature. Such electric current is defined as “inrush current,” wherein if a halogen lamp consumes a larger amount of electric power, the inrush current will be increased. In this regard, a problem arises in that as a halogen lamp, which consumes a large amount of electric power consumption, is driven, electric power supplied to an electronic appliance (not shown) located around the halogen lamp is reduced due to the large amount of inrush of current provided to the halogen lamp. As a result, the electronic appliance may malfunction.

FIG. 3 shows an example of control pulses applied to the triac 15 from the switching section 13. When the twenty cycles constitute one period, the shown pulses indicate that only a quarter of applied AC power source 10 is applied to the halogen lamp 11. As a result, the temperature of the halogen lamp 11 is controlled by the AC power source 10. The AC power source 10, in this case may be limited to a quarter of the total AC power that is applied to the halogen lamp 11. The points at which an AC cycle is turned either from positive (+) to negative (−) or from negative (−) to positive (+) during AC cycles by the AC power source 10 are defined as zero-crossing. However, when the halogen lamp 10 is restarted in the state in which a temperature thereof has been lowered, there is a problem in that a large amount of inrush current flows in the halogen lamp 11.

FIG. 4 illustrates another example of control pulses applied to the triac 15 from the switching section 13 shown in FIG. 1. The illustrated pulses are those taken by slicing the pulses of the AC power source 11 according to the temperature of the halogen lamp 11. Among the illustrated pulses, the black areas C comprise a waveform of the AC power source passing through the triac 15 under the control of the switching section 13. The electric power applied to the halogen lamp 11 increases or decreases through a control such that, as the temperature increases the size of black areas C decreases while the size of white areas B increases. Such a control method is defined as a phase control method. Here, controlling the temperature of the halogen lamp by controlling the electric power practically applied to the halogen lamp 11 is possible. In a phase control method, if the temperature of the halogen lamp 11 is very high, the width of areas C will be reduced. As the width of areas C is reduced, the waveform of electric current, which passes through the halogen lamp 11 and the triac 15, approaches an impulse or harmonic. As a result however, a noise may be applied to an electronic appliance (not shown) positioned around the halogen lamp.

### SUMMARY OF THE INVENTION

Accordingly, an aspect of the present invention provides a lamp control method to reduce the inrush of current to the lamp, which is used as a heating element, without generating a harmonic, and a method of controlling an image forming apparatus to reduce the inrush of current to the image forming apparatus.

The above aspect of the present invention may be achieved by providing a lamp control method, comprising detecting a temperature of a lamp, comparing the detected temperature of the lamp with a predetermined reference temperature, turning off a power supply to the lamp when the detected temperature of the lamp exceeds the predetermined reference temperature, and when the lamp stays in turned-off state more than a first time amount, supplying a half wavelength pulse to the lamp at intervals according to a second time amount.

The power supply may be switched in accordance with one of the methods of zero-crossing control and phase control.

According to another aspect of the present invention, a lamp control method of an image forming apparatus comprises detecting a temperature of a lamp which heats a fixing roller of the image forming apparatus, turning off a power supply to the lamp when the detected temperature of the lamp exceeds a predetermined reference temperature, and when the lamp stays in turned-off state more than a first time amount, supplying a half wavelength pulse to the lamp at intervals according to a second time amount.

The predetermined reference temperature may be set with respect to a stand-by mode of the image forming apparatus.

The predetermined reference temperature may be set with respect to a printing mode of the image forming apparatus.

The power supply may be switched in accordance with one of the methods of zero-crossing control and phase control.

The lamp comprises a halogen lamp.

The supplying the half wavelength pulse to the lamp at intervals according to the second time amount may be performed when the image forming apparatus is in a stand-by mode.

According to another aspect of the present invention, a lamp control method comprises detecting a temperature of a lamp, based on the detected temperature, supplying a switching-controlled power to the lamp to maintain the lamp at a predetermined temperature, and supplying a half wavelength to the lamp when the lamp stays off for more than a first time amount during the switching of the power supply.

The power supply may be provided to the lamp in accordance with one of the methods of zero-crossing control and phase control.

The lamp comprises a halogen lamp.

The supplying the half wavelength pulse is performed when the temperature of the lamp reaches and maintains the predetermined temperature.

Additional and/or other aspects and advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a view to conceptually illustrate a method of controlling a halogen lamp incorporated within a conventional fixing roller;

FIG. 2 is a graph showing a driving characteristic of the halogen lamp shown in FIG. 1;

FIG. 3 is a view showing an example of pulses applied to a triac from a switching section shown in FIG. 1;

FIG. 4 is a view of another example of pulses applied to the triac from the switching section shown in FIG. 1;

FIG. 5 is a view showing an embodiment for a fixing roller of an image forming apparatus and a peripheral circuit to control the fixing roller to execute the inventive lamp control method;

FIG. 6 is a view showing another form of a pulse applied to the fixing section from a switching section;

FIG. 7 is a flowchart showing a lamp controlling method to reduce an inrush of current according to an embodiment of the present invention;

FIG. 8 is a flowchart showing a method to control a standby mode of the fixing section of an image forming apparatus by using a lamp control method to reduce an inrush of current according to an embodiment of the present invention; and

FIG. 9 is a flowchart showing a lamp controlling method to reduce an inrush of current according to another embodiment of the present invention.

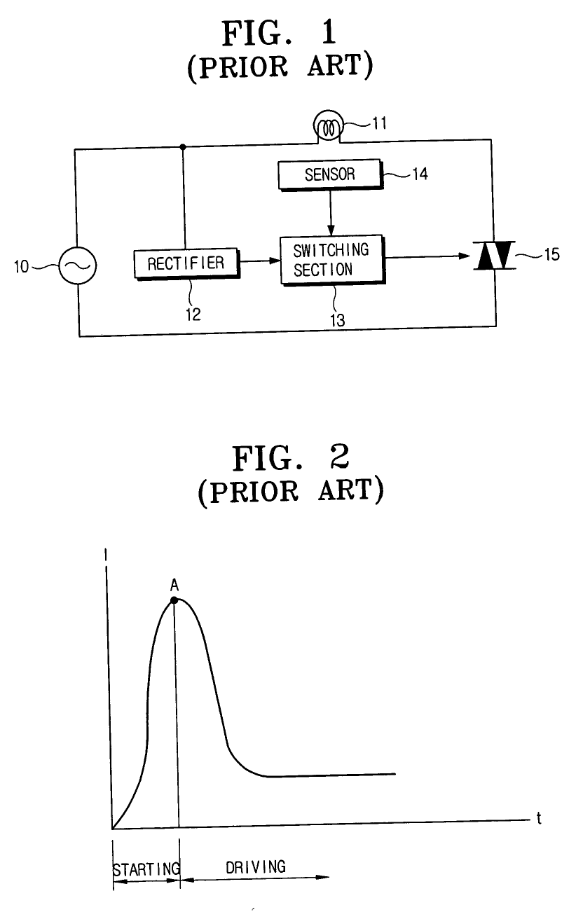

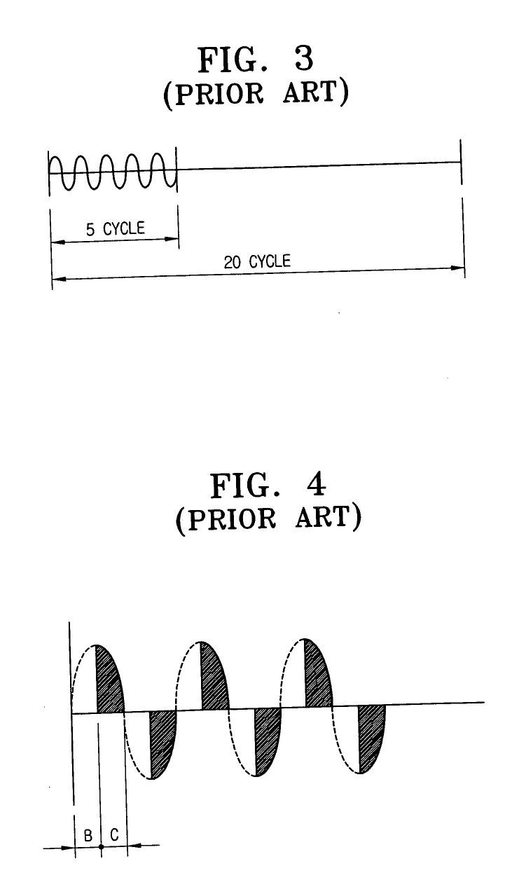

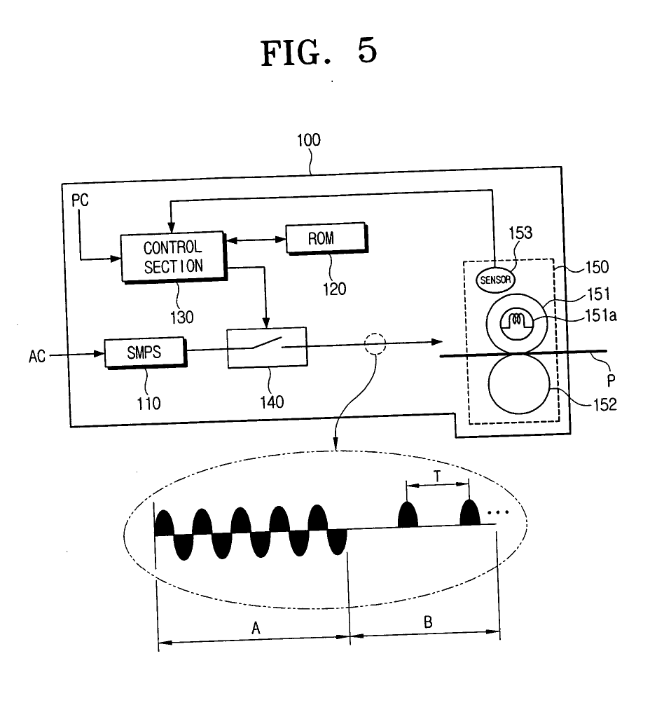

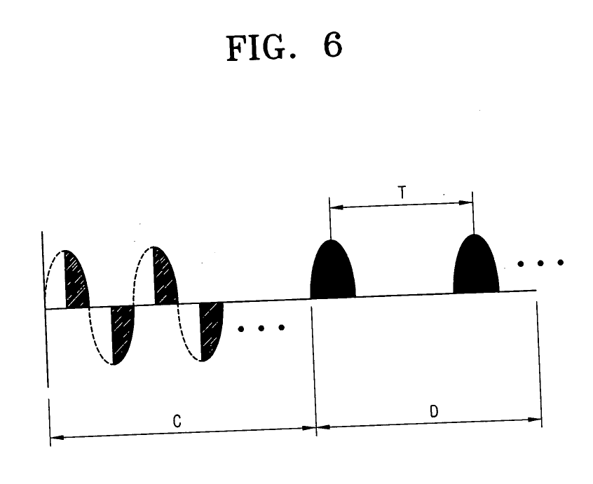

### DETAILED DESCRIPTION OF THE EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

FIG. 5 shows an embodiment of a fixing roller of an image forming apparatus and a peripheral circuit to control the fixing roller to execute the inventive lamp control method.

The fixing roller and the peripheral circuit to control the fixing roller comprise a switching mode power supply (SMPS) 110, a read only memory (ROM) 120, a control section 130, a switching section 140, and a fixing section 150.

The SMPS 110 rectifies commercial alternating current (AC) to generate various direct voltages as are required by the image forming apparatus. The ROM 120 stores various control programs to drive the image forming apparatus. A control program stored in the ROM 120 controls the temperature of the fixing section 150. The control section 130 controls the switching section 140 in accordance with the control program stored in the ROM 120. When the image forming apparatus operates in a stand-by mode, i.e., in a waiting state, a temperature of the fixing section 150 should be maintained at a predetermined temperature. At this time, if electric power is not supplied to the fixing section 150 over a long time, the temperature of the heating element to heat the fixing section 150 occasionally decreases excessively. If the temperature of the heating element decreases excessively, an inrush of current is generated so as to restart the fixing section 150. The fixing section 150 comprises two rollers 151, 152 to heat and compress toner adhered to a paper P, in which one of the two rollers 151, 152 (e.g., the roller 151) is provided with a lamp 151a that is driven by electric power supplied from the SMPS 110. According to an embodiment of the invention, the lamp 151 is a halogen lamp that has a long life and generates a high temperature. Even if the roller 151 is maintained at a predetermined temperature, a large amount of electric current is required to heat the filament (not shown) of the lamp 151a when the lamp 151a is restarted if the lamp 151a is cooled. Accordingly, a voltage applied to an electronic appliance located around the image forming apparatus may be reduced as described above with reference to FIG. 2. The present invention solves this problem by driving the lamp 150 at predetermined intervals.

FIG. 5 shows a form of pulses applied to the fixing section 150 from the switching section 140. The interval “A” indicates a control pulse interval to keep the temperature of the lamp 151a constant, and the interval “B” indicates the form of pulses, which are applied to the lamp 151a when the fixing rollers 151, 152 are heated to a predetermined temperature by the lamp 151a. In the interval “A,” a series of control pulses maintain the temperature of the fixing section and in the interval “B,” a series of pulses prepare the lamp 151a to be restarted in the interval during which the lamp 151a is turned off. The time interval T between each pair of pulses may have various values depending on heat generating and heat emitting characteristics of the heating element. Here, control of the temperature of the lamp 151a may be performed according to various control methods. After the temperature of the lamp 151a reaches a proper value, the filament of the heating element may be maintained at a predetermined temperature by applying a half-wavelength pulse to the lamp 151 at predetermined time intervals depending on the heat generating and heat emitting characteristics of the lamp 151a. As a result, if the temperature of the lamp 151a is controlled, no harmonic will be generated in the image forming apparatus provided with such a lamp 151a and reducing an inrush of current will be possible.

FIG. 6 shows another form of pulses that are applied to the fixing section 150 from the switching section 140. As illustrated in the interval “C,” pulses adjust the temperature of the lamp 151a to a desired temperature, and as illustrated in the interval “D,” half-wavelength pulses are each applied to the lamp 151a at predetermined time intervals when the lamp 151a is heated to the desired temperature. In the interval “C”, a series of pulses are applied according to a phase control method. The phase control method is a useful method to reduce an inrush of current. If a series of pulses according to the phase control method are applied to the lamp 151a, the pulses shown in the interval “D” may reduce an inrush of current but a harmonic noise that is peculiar to the phase control method may be produced.

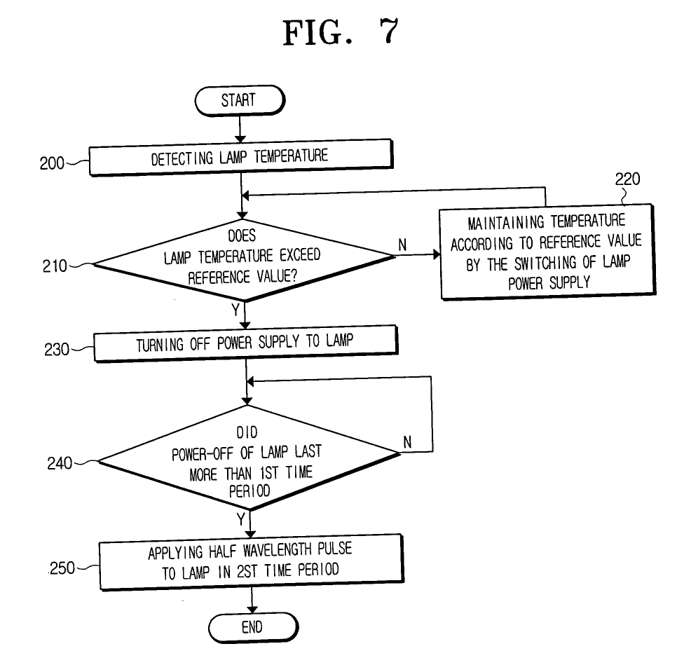

FIG. 7 shows a flowchart of an embodiment of the inventive lamp control method to reduce an inrush of current.

First, electric power is applied to a lamp 151a that is employed as a heating element to heat the lamp, and the temperature of the lamp 151a is detected (200). In an embodiment of the invention, the temperature of the lamp is detected using a temperature sensor such as the sensor 153, which is attached onto or adjacent to the surface of the lamp 151a. Next, a reference temperature value is set depending on the use of the lamp 151a which is then compared with the detected temperature to confirm whether the detected temperature exceeds the reference temperature value (210). To this end, the sensor 153 and hardware to switch the power supply to the lamp 151a in accordance with temperature detected by the sensor 153 may both be required. The above-mentioned hardware may be hardware that is generally provided in a device to drive the lamp 151a. FIG. 5 illustrates one example of the image forming apparatus having the above-mentioned structure, in which the temperature detected by the temperature sensor 153 is compared with the reference temperature value stored in the ROM 120 in the control section 130, and the control section 130 controls the switching section 140 depending on the comparison result. The switching section 140 turns off the lamp 151a when the temperature of the lamp 151a exceeds the reference value (230) and maintains the temperature of the lamp 151a by switching the power supply to the lamp 151a when the temperature of the lamp 151a is in the reference value range (220). Here, the “reference value” is a value within upper and lower limits. The upper and lower limits are preset depending on the use of the lamp 151a. Next, if electric current to the lamp 151a stays in an off-state for a predetermined time period, the control section 130 applies a half-wavelength pulse to the lamp 151a at predetermined time intervals (250). In various embodiments of the invention, the application of the half-wavelength pulses to the lamp 151a by the control section occurs if electric current to the lamp 151a stays in the off-state for approximately 300 ms-900 ms. Further, the predetermined time intervals during which the half-wavelength pulses are applied to drive the lamp 151a may be approximately 500 ms. In this manner, the filament incorporated within the lamp 151a will be maintained at a predetermined temperature and an excessive inrush of current will not be generated when the lamp 151a is heated.

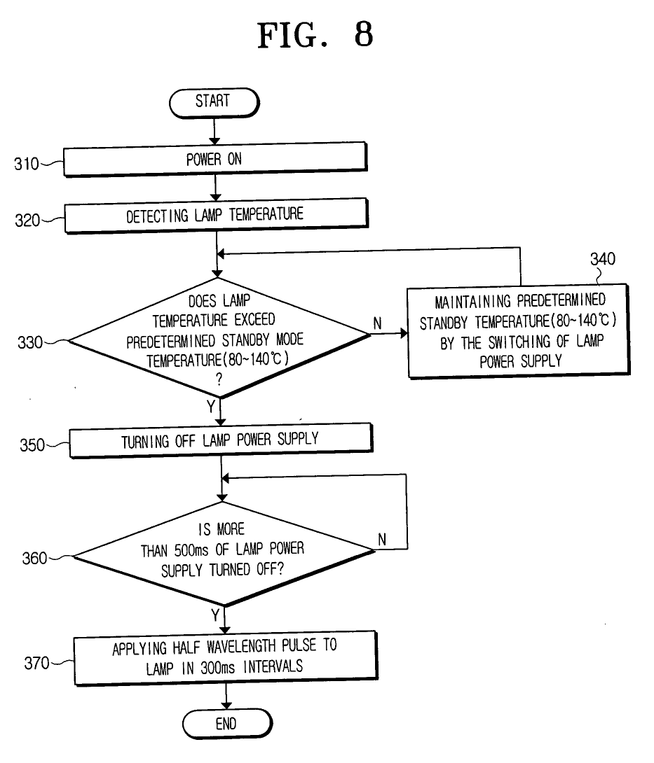

FIG. 8 shows another embodiment according to the inventive method of controlling an image forming apparatus, to which the inventive lamp control method for reducing inrush current is applied.

First, an image forming apparatus (e.g., printer, facsimile, scanner, copier, etc.) is powered-on (310) so as to heat a fixing section 150 provided in the image forming apparatus (320). The fixing section 150 comprises a sensor 153 to detect the temperatures of a pair of rollers 151, 152 to compress and thermally transfer toner or ink adhered on a paper P. In addition, a halogen lamp 151a is incorporated in the roller 151 to heat the roller 151. The halogen lamp 151a comprises a filament and a glass bulb, in which a halogen gas is introduced. Such a halogen lamp projects light with very high brightness and a surface thereof is heated up to several hundred degrees centigrade. When the halogen lamp 151a is heated, the heat of the halogen lamp 151a is transferred to the roller 151. Next, the sensor 153 converts the detected temperature of the roller 151 into a digital signal and applies the digital signal to a control section 130. The control section 130 compares the temperature detected by the sensor 153 with a temperature previously stored in a ROM 120 (330). For example, as the proper temperature is typically 80° C. to 140° C. when the image forming apparatus is in the stand-by mode, and typically 170▾ to 200▾ in the printing mode, the control section 130 determines whether the detected temperature is within the range of 80° C. to 140° C. when the image forming apparatus is in the stand-by mode, and whether the detected temperature is within the range of 170° C. to 200° C. when the image forming apparatus is in the printing mode. If the temperature detected by the sensor 153 is determined to be out of the proper temperature range (80° C. to 140° C. in stand-by mode, and 170° C. to 200° C. in printing mode), power supply to the lamp 151a is turned off (350).

Next, the control section 130 switches the electric current supply to the lamp 151a, so that the temperature of the roller 151 may be maintained within the proper temperature range, for example, within the range of 170° C. to 200° C. when in printing mode (340). The electric current supply to the halogen lamp 151a may be in pulse form, and the pulse may have an appropriate form according to zero-crossing or phase control. When a predetermined time, 300 ms to 900 ms for instance, elapses after the power-off of the halogen lamp 151a (360), the control section 130 regularly applies a half-wavelength pulse to the lamp 151a at predetermined time intervals to maintain the driving of the lamp 151a (370). In this manner, the lamp 151a is maintained at a predetermined temperature range, which, in an embodiment of the invention, may be approximately 170° C.˜180° C. in printing mode. As a result, an excessive inrush of current is avoided.

As is described above, according to the present invention, a reduction of an inrush of current to a lamp employed as a heating element is possible without a need to provide separate hardware.

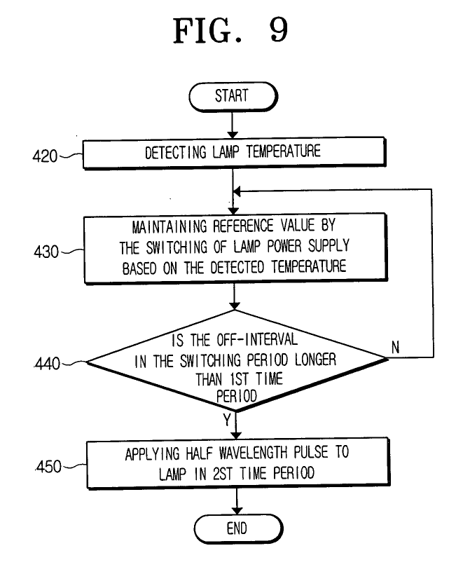

FIG. 9 is a flowchart of a lamp control method to reduce an inrush of current according to another embodiment of the present invention.

First, electric current is applied to the lamp 151a, which is employed as a heating generator, and the temperature of the heated lamp 151a is detected (420). The temperature may be detected by the temperature sensor such as the sensor 153 which is attached onto or adjacent to the surface of the lamp 151a. Next, based on the detected temperature, electric current, which is switched by the zero-crossing pulse or phase-control slicing pulse, is supplied to the lamp 151a so that the lamp 151a may reach a predetermined temperature range (430). The predetermined temperature range may vary depending on the environment of use, from several tens of Celsius degrees to several hundreds of Celsius degrees. When the lamp 151a is used in the laser printer as a heat generator, for example, the predetermined temperature may be 80° C.˜140° C. in stand-by mode, and 170° C.˜200° C. in the printing mode.

Hardware to support the above described method may be general hardware that is usually provided in the lamp driving equipment. That is, in the appliance having a lamp as the heat generator, a sensor to detect the temperature of the lamp and a processor to control the pulse-type electric current, which is applied to the lamp in accordance with the result of the sensor detection, are usually provided. As a result, the lamp control method according to the present invention does not require additional hardware to reduce an inrush of current to the lamp.

Next, zero-crossing or phase control methods are operated to switch the power supply to the lamp and maintain the lamp at a predetermined temperature when power-off time exceeds a predetermined time such as 500 ms (440). As such, a half wavelength pulse is applied to the lamp to continue the driving of the lamp. Otherwise the method reverts to operation 430 in which the pulse-type electric current to the lamp is switched so as to maintain the temperature of the lamp at a predetermined degree.

As a result, minimizing an inrush of current, which is generated in an electronic appliance employing a lamp as a heating element, is possible without a need to use separate hardware. In particular, when a lamp is used as a heating element in the aforementioned control method in an electronic appliance, such as a printer, a facsimile, a composite machine, or the like, a reduction of an inrush of current, which may be generated in the course of maintaining the temperature of a fixing device of the electronic appliance at a predetermined temperature in the stand-by state of the electronic appliance, is possible by programming the appliance in such a manner that half wavelength pulses are applied at predetermined time intervals and for a certain time during which, under the control on the temperature of the fixing device, the predetermined electric current to the lamp is cut off. According to an embodiment of the invention, for the certain time may be 300 ms after the turn-off of the lamp.

Although a few embodiments of the present invention have been shown and described, it would be appreciated by those skilled in the art that changes may be made in these embodiments without departing from the principles and spirit of the invention, the scope of which is defined in the claims and their equivalents.

1. A method to control a lamp, comprising:
detecting a temperature of lamp, and comparing the detected temperature of the lamp with a predetermined reference temperature;
turning off a power supply to the lamp when the detected temperature of the lamp exceeds the predetermined reference temperature; and
when the lamp stays in a turned-off state for more than a first amount of time, supplying a half wavelength pulse to the lamp at intervals according to a second time amount.

2. The lamp control method of claim 1, wherein the power supply is switched in accordance with one of zero-crossing control and phase control methods.

3. A lamp control method of an image forming apparatus, comprising:
detecting a temperature of a lamp which heats a fixing roller of the image forming apparatus;
turning off a power supply to the lamp when the detected temperature of the lamp exceeds a predetermined reference temperature; and
when the lamp stays in a turned-off state for more than a first time amount, supplying a half wavelength pulse to the lamp at intervals according to a second time amount.

4. The lamp control method of claim 3, wherein the predetermined reference temperature is set with respect to a stand-by mode of the image forming apparatus.

5. The lamp control method of claim 3, wherein the predetermined reference temperature is set with respect to a printing mode of the image forming apparatus.

6. The lamp control method of claim 5, wherein the power supply is switched in accordance with one of zero-crossing control and phase control methods.

7. The lamp control method of claim 3, wherein the lamp comprises a halogen lamp.

8. The lamp control method of claim 3, wherein the supplying the half wavelength pulse to the lamp at intervals according to the second time amount is performed when the image forming apparatus is in a stand-by mode.

9. A lamp control method, comprising:
detecting a temperature of a lamp;
based on the detected temperature, supplying a switching-controlled power to the lamp and maintaining the lamp at a predetermined temperature; and
supplying a half wavelength to the lamp when the lamp stays off for more than a first time amount during the switching of the power supply.

10. The lamp control method of claim 9, wherein the power supply is provided to the lamp in accordance with one of zero-crossing control and phase control methods.

11. The lamp control method of claim 9, wherein the lamp comprises a halogen lamp.

12. The lamp control method of claim 9, wherein the supplying the half wavelength pulse is performed when the temperature of the lamp reaches and maintains the predetermined temperature.

13. A circuit to control a fixing section, including a fixing roller having a lamp to occupy on and standby modes and a ROM to store a program to control the lamp, of an image forming apparatus, comprising:
a power supply to power the lamp;
a switch to generate a first set of pulses of power to maintain a constant temperature of the lamp in the on-mode and a second set of pulses of power to maintain a temperature of the lamp in the standby-mode; and
a control section to control the switching section in accordance with the program to control a temperature of the lamp.

14. The circuit according to claim 13, wherein the power is switched in accordance with one of zero-crossing control and phase control methods.

15. A lamp control method to reduce an inrush of current to the lamp, comprising:
detecting a temperature of the lamp to determine whether the temperature exceeds a predetermined temperature;
maintaining the temperature if the temperature of the lamp does not exceed the predetermined temperature;
turning of power to the lamp if the temperature exceeds the predetermined temperature;
determining if the lamp is turned off for more than a first predetermined period; and
turning on the power to the lamp in pulses separated by time intervals of a second predetermined period if the lamp is turned off for more than the first predetermined period.

16. The lamp control method according to claim 15, wherein the maintaining the temperature comprises switching of a power supply to the lamp.

17. The lamp control method according to claim 15, wherein the pulses comprise half-wavelength pulses.

18. The lamp control method according to claim 15, wherein the first predetermined period is approximately 300-900 ms.

19. The lamp control method according to claim 15, wherein the second predetermined period is approximately 500 ms.
